(19) United States
(12) Patent Application Publication
(10) Pub. No.: US 2010/0058016 A1
(43) Pub. Date: Mar. 4, 2010

(54) METHOD, APPARATUS AND SOFTWARE PRODUCT FOR MULTI-CHANNEL MEMORY SANDBOX

(76) Inventors: Jari Nikara, Tampere (FI); Kimmo Kuusilinna, Tampere (FI); Tapio Hill, Helsinki (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 12/198,839

(22) Filed: Aug. 26, 2008

(51) Int. Cl. G06F 12/14; G06F 12/00; G06F 12/02; G06F 12/08

(52) U.S. Cl. 711/163; 711/170; 711/206; 711/E12.001; 711/E12.002; 711/E12.093; 711/E12.059

(57) ABSTRACT

A method, apparatus, and software product allow signalling toward a multi-channel memory subsystem within an application processing architecture, and routing of that signalling via a single sandbox which provides memory protection by controlling memory usage and blocking the signalling if it is unauthorized. The signalling via the sandbox leads to a plurality of different memory locations, and the sandbox is an intermediary for substantially all execution memory accesses to the multi-channel memory subsystem.

### FIELD OF THE INVENTION

The invention relates to handheld electronic devices, including but not limited to communication devices, and more particularly relates to multi-channel memory.

### BACKGROUND OF THE INVENTION

The currently predicted bandwidth requirement for multimedia-capable (high-end) mobile communication devices during the next several years is approximately 10 gigabytes per second (10 GB/s). This requirement is mainly driven by the needs of Motion Picture Experts Group Advanced Video Coding standard (e.g., MPEG4/AVC 1080p video recording at 30 frames per second (fps)). The only known technology capable of delivering this bandwidth, in practice, is multi-channel memory (MCMem). Multi-channel means that there are multiple (i.e. more than one) separate and parallel paths to execution memory (e.g. dynamic random access memory abbreviated as DRAM) from which data can be accessed. Multi-channel differs from multi-port, so that in multi-port all the ports access the same physical memory, whereas in multi-channel the channels lead to physically different memory locations.

Multi-channel implementations have so far been relatively limited due to package input-output (1/0) pin requirements for the multiple channels. However, two contemporary technological trends are changing this situation. One contemporary trend is 3D die stacking. Die stacking, otherwise known as “chip stacking”, is a process of mounting multiple chips on top of each other within a single semiconductor package, and 3D die stacking may increase transistor density by vertically integrating two or more die with a dense, high-speed interface. Hundreds and later even thousands of connections can be manufactured between the dies. A second contemporary trend is towards serial interconnections that reduce the I/O pins in a single channel.

A memory management unit (MMU) or paged memory management unit (PMMU) is a computer hardware component responsible for handling accesses to memory requested by the central processing unit (CPU). The duties of the MMU include the following: translation of virtual addresses to physical addresses (e.g. as part of virtual memory management), memory protection, maintaining scatter-gather list, cache control, and bus arbitration. Memory protection is a way of controlling memory usage on a computer, and is central to virtually every operating system; the main purpose of memory protection is to prevent a process running on an operating system from accessing memory beyond that allocated to it. This prevents a bug within the process from affecting other processes, and also prevents malicious software from gaining unauthorized access to the system.

An operating system typically assigns a separate virtual address space to each program. MMUs divide the virtual address space into pages, a page being a block of contiguous virtual memory addresses whose size is (typically) 4 kilobytes. MMU translates virtual (also called “logical” or “linear”) page numbers to physical page numbers via a cross-reference known as a page table. A part of the page table is cached in a Translation Lookaside Buffer (TLB).

In a computer with virtual memory, the term “physical address” is often used to differentiate from a “virtual address”. In particular, in a computer utilizing an MMU to translate memory addresses, the virtual and physical address refer to address before and after MMU translation, respectively. Almost all implementations of virtual memory use page tables to translate the virtual addresses seen by the application program into physical addresses (also sometimes referred to as “real addresses”) used by the hardware to process instructions. Systems can have one page table for the whole system or a separate page table for each application. Paging is the process of saving inactive virtual memory pages to disk and restoring them to real memory when required.

When a CPU fetches an instruction located at a particular virtual address or, while executing an instruction, fetches data from a particular virtual address or stores data to a particular virtual address, the virtual address typically must be translated to the corresponding physical address. This is usually done by the MMU, which looks up the real address (from the page table) corresponding to a virtual address. If the page tables indicate that the virtual memory page is not currently in real memory, the hardware raises a page fault exception (special internal signal) which invokes the paging supervisor component of the operating system (see below).

If a continuous memory allocation from the virtual address space is larger than the largest available continuous physical address range, then the physical allocation must be formed from several memory ranges. This scatter-gather implementation is a development of the simpler page table arrangement that can only access continuous physical memory. Due to naturally occurring memory fragmentation while the device is used, the simpler implementation has an unfortunate tendency to run out of memory even if ample memory is theoretically free.

A page fault happens when, for example, a virtual page is accessed that does not have a physical page mapped to it. The operating system (OS) can use this information to protect the memory from errant programs accessing memory areas to which they should not have access.

A typical MMU works in a centralized environment that contains one master CPU and the OS running on it. In this configuration, the OS knows how the memory is allocated and can move the data and allocations around if necessary. This can be useful to form larger continuous physical memory areas and to put the unused memory areas into a power saving state. According to current application processing engine (APE) architecture, if MMU-like functionality is found anywhere else than directly associated with the CPU, it is typically very limited in functionality (e.g. limited to scatter-gather functionality).

### SUMMARY OF THE INVENTION

The invention, a multi-channel memory sandbox, primarily takes care of memory protection in a multi-channel memory subsystem. The multi-channel memory sandbox may also encapsulate more MMU functionality, for example dynamic memory allocation. Dynamic memory allocation is allocation of memory storage for use in a program during the runtime of that program, and can also be used as a way of distributing ownership of limited memory resources among many pieces of data and code. The sandbox of the present invention provides a way to determine which channel each address belongs to, and provides information about what address bits to use on that channel.

The term “sandbox” has been used in the past with reference to a protected, limited area in computer memory where applications are allowed to function without risking damage to the system that hosts them. A security protocol is sometimes employed in a Java context, in order to implement a software sandbox as a space in a client's memory beyond which the Java applet cannot write data. Also, multiple hardware sandboxes are sometimes used, to provide for security against corruption of data among multiple programs being processed by multiple processing units.

According to an embodiment of the present invention, the multi-channel memory sandbox is located between the system interconnect and the multi-channel memory subsystem. If the present invention is implemented from virtual addresses, then it could be described as a centralized address-channel calculator apparatus.

The sandbox of the present invention may also contain scatter-gather functionality. Scatter-gather is used to do direct memory access (DMA) data transfers of data that is written to noncontiguous areas of memory. DMA allows certain subsystems to access system memory for reading and/or writing independently of a central processing unit (CPU). A scatter-gather list is a list of vectors, each of which gives the location and length of one segment in the overall read or write request.

Generally speaking, without some channel allocation scheme, a multi-channel memory architecture does not work, and the present invention describes a solution to this problem. Various embodiments of this invention offer various advantages, such as memory protection that prevents erroneous code (or malfunctioning memory masters or malicious memory masters) from accessing and corrupting memory regions where they do not belong. Another of the advantages is platform security, which is of growing concern in new devices. A further advantage is that the required changes to contemporary state-of-the-art solutions can be relatively minor, the main issue being that the sandbox should understand the microprocessor's page table format. Various embodiments of this invention can also be adapted to more complex state-of-the-art systems, thus requiring more substantial changes to the architecture.

Since the sandbox is the intermediary in all execution memory accesses, it can be further enhanced to [1] optimize memory access times through the use of application specific data interleaving, [2] enable the use of aggressive power down modes for parts of the memory, since the sandbox knows which channels and parts of the memory are actually used, [3] support complex address mapping functions, [4] perform physical memory accesses out-of-order to optimize performance, and [5] allow more dynamic behavior such as changing memory configuration in run-time (interleaving granularity). The sandbox enables the modularization of the memory subsystem so that the memory subsystem becomes more independent from the rest of the system.

### BRIEF DESCRIPTION OF THE DRAWINGS

FIG. 1 shows an application processing engine with multi-channel memory sandbox.

FIG. 2 is an example of a multi-channel memory system with two channel clusters.

FIG. 3 shows in tabular form an embodiment of an address-channel calculation according to an embodiment of the present invention

FIG. 4 is a flow chart showing a method according to an embodiment of the present invention.

FIG. 5 is a block diagram of an embodiment of the present invention.

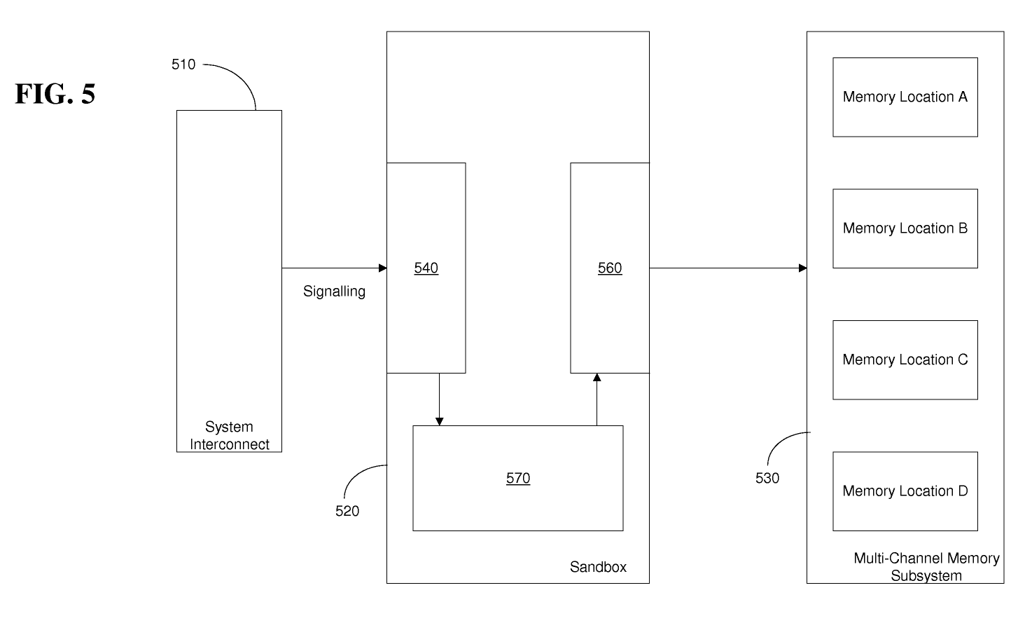

### DETAILED DESCRIPTION OF AN EMBODIMENT OF THE INVENTION

In the multi-channel memory environment, there are important issues that the conventional MMU does not adequately address. A first problem with the conventional MMU is that there is no centrally supervised memory protection for the memory accesses from video and graphics subsystems.

A second problem with the conventional MMU is that, in addition to managing the physical address space, the channel allocation for addresses and between memory masters needs to be arranged. To maximize resource usage, the allocation should generally be dynamic. Dynamic means that physical memory regions can be allocated for processes and subsequently these allocations can be freed at run-time, making memory available for other processes.

A third problem with the conventional MMU is that the centralized environment with one master CPU and one OS is no longer valid for some modem wireless communication devices. The device contains multiple masters that are capable of independently generating memory accesses. Some examples are the main CPU, video subsystem, and graphics subsystem. Currently, there is no centrally supervised memory protection for the memory accesses from video and graphics subsystems.

A fourth problem with the conventional MMU is that, currently, large static memory allocations are performed at boot time for video and graphics buffers. The OS does not necessarily know which parts of these allocations are actually used and, therefore, cannot apply the most aggressive power management strategies to these regions.

Further problems with the convention MMU include that the memory is tightly coupled to the rest of the system, and thus modularity is restricted. Additionally, recent MMU systems are designed by assuming a single-channel memory architecture.

Preferably, there is a multi-memory-master Application Processing Engine (APE) architecture where the MMU functionality is distributed among the memory masters. Alternatively, the MMU function could be centralized to reside between the system interconnect and the multi-channel memory subsystem.

The problems described above did not exist previously, because the memories have been single-channel. In classical computer science, multi-channel memories have been used to a limited extent in standard computing machinery. A typical setup would be to direct even-numbered addresses to one channel, and to direct odd-numbered addresses to another channel. This requires almost no additional intelligence from the MMU. Also, more channels have been used following the same kind of logic. In all the related art implementations, the access to the memory system has been from a single point (master). This single point has been the enabling factor for conflict-free memory allocation and ensuring that memory accesses do not overlap.

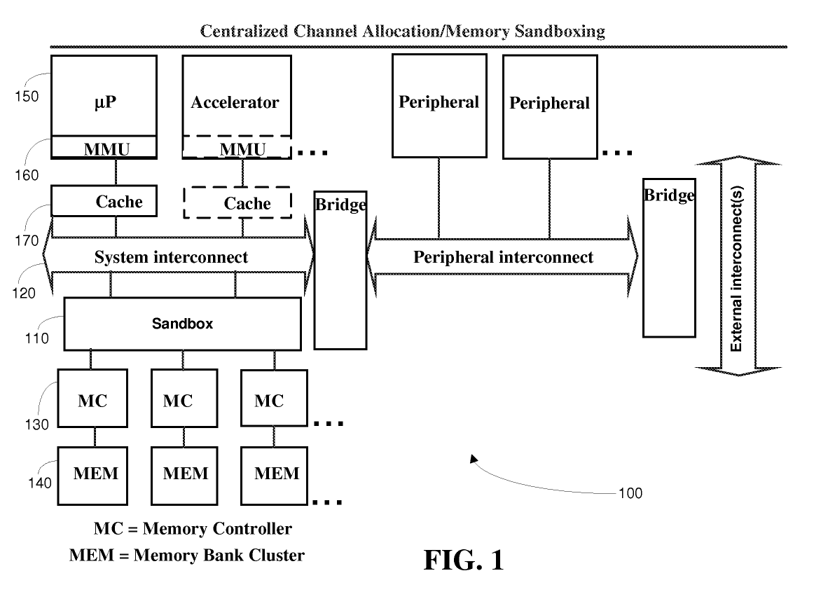

According to an embodiment of the present invention shown in FIG. 1, the multi-channel memory sandbox 110 is located between the system interconnect 120 and the multi-channel memory subsystem. Thus, the sandbox separates the multi-channel memory subsystem (including memory controllers 130 and memory bank cluster 140) from other parts of the application processing engine architecture 100 such as the microprocessor core subsystem (including microprocessor 150, MMU 160, and cache 170). The system interconnect 120 is a memory interconnection among at least the microprocessor core subsystem and (via the sandbox) the multi-channel memory subsystem.

This embodiment of the invention includes two alternative implementations. The first implementation, which is less complex, can augment contemporary solutions. The second implementation is more complex, and targets future modular designs.

According to the first implementation, the MMU of the microprocessor (μP) solely manages the system memory map. This is done using the page table. The page table may be cached in a TLB. In addition to the other page table contents, each entry has a process identification (PID) field. The traditional PID is the process number associated with a specific process in the microprocessor. However, here the meaning is a bit relaxed and there may be, for example, a single PID for a specific accelerator component. Every access originating from this accelerator would use this PID.

In this first implementation, the other possible memory masters may or may not have their own MMUs. In any case, these MMUs only manage the memory for their respective dedicated memory masters, not the whole system. Each of these MMUs may also have a TLB. If a memory master does not have an MMU, then the master uses physical addresses without any translation.

The first implementation includes the page table being stored in memory or memories (MEM). The sandbox can and must read the page table, and the sandbox can also have a TLB. The sandbox is accessed with a physical address, PID, and command (read or write). If the access PID equals the table PID for that physical address, then the access request is implemented; this is the memory protection function. If the PIDs do not match, then no action is taken. Optionally, the sandbox can signal the error condition to the microprocesser or the originating memory master. For a successful access, the sandbox converts physical addresses to channel addresses.

According to the second implementation, only the sandbox manages the system page table, and again there is a PID for every page entry. There may be a TLB in the sandbox. The page table is always stored in MEM(s).

The second implementation includes access to the sandbox either with an allocation request, or a de-allocation request, or alternatively an access request. For the allocation request, which includes allocation size, PID, and optional quality metadata, the sandbox forms an appropriate memory allocation and page table entry, the sandbox returns a virtual address (interconnect addresses are separate from the memory addresses), and there may be restrictions in which memory masters may make new allocations. For the de-allocation request, which includes a virtual address as is returned for the allocation request and also includes PID, a success/failure code may be returned to the originating memory master. The access request includes virtual address, PID, and a read or write command.

In the second implementation, for an access request, if an access PID equals a table PID, and the matching virtual address is mapped in the page table, then the access request is implemented. This is a memory protection function. If the PIDs do not match, then no action is taken. Optionally, the sandbox can signal the error condition to the microprocessor or to the originating memory master. For a successful access, the sandbox converts virtual addresses to channel addresses. A sandbox may use all normal MMU techniques to manage the virtual to physical memory space mapping, for example scatter-gather.

There is an even more secure version of the second implementation, in which the sandbox generates the PIDs. This requires that the page table also tracks the originators of the memory allocations, for instance by storing the interconnection address. This is different from a typical scenario in which an access request, the PID, the interconnection address, and the virtual address range have to match for the access to be implemented. The second implementation also enables treatment of memory as an independent subsystem in its own right. This would be a change as compared to the contemporary state-of-the-art solutions (e.g. application software, OS, and programming models).

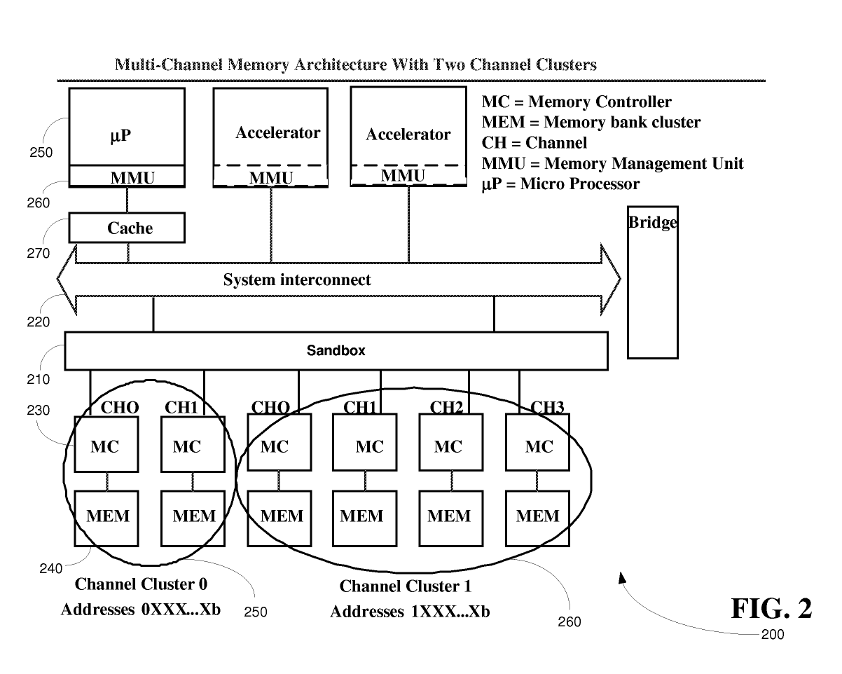

The implementations described above can also be used with a channel clustering (CL) scheme. With channel cluster, the physical address space can be divided between different multi-channel or single-channel memory subsystems. For instance, if there are two separate four-channel memory subsystems, then the most significant bit of the physical address can be used to distinguish between the subsystems. FIG. 2 shows another example of a multi-channel memory system 200, with two channel clusters 250 and 260. The multi-channel memory sandbox 210 is located between the system interconnect 220 and the multi-channel memory subsystem. Thus, the sandbox separates the multi-channel memory subsystem (including memory controllers 230 and memory bank cluster 240) from other parts of the application processing engine architecture 200 such as the microprocessor core subsystem (including microprocessor 250, MMU 260, and cache 270).

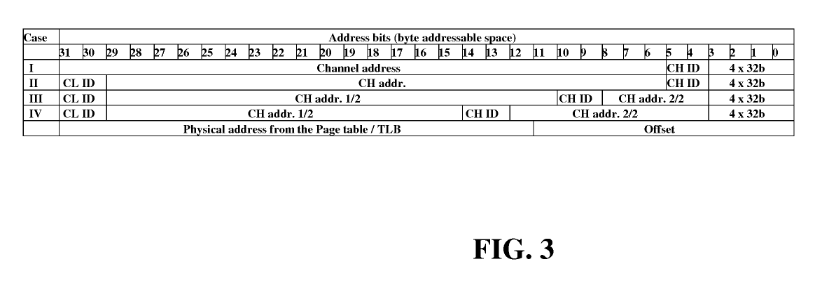

Memory allocations never cross channel cluster boundaries. That is, a memory allocation always reserves physical memory locations from all the memory components in a single channel cluster. Furthermore, a memory allocation never allocates memory from multiple channel clusters. If the system only contains one channel cluster, it does not need addressing or bits, as shown in FIG. 3, case I. Cases II-IV in FIG. 3 assume a system with four channel clusters, so two topmost bits are reserved for this selection. In all of the cases shown in FIG. 3, the four lowest bits (numbered 0-4) are not used at this stage, since they correspond to addresses that are too detailed to be accessed with this arrangement. Both case I and case II use a system default interleaving scheme. If the MMU only supports one physical address layout, and the channel selection algorithm can be hardwired to the Address-channel calculation, then the channel configuration information is unnecessary. However, if a selection of different memory subsystem usage models (e.g. the cases in FIG. 3) is desired or the channel selection algorithm is complex, then the channel configuration information will be needed. For instance, if a system that supports the four cases in FIG. 3 needs to be built, then it is necessary to reserve two bits for the Channel configuration in the page table/TLB.

It should also be noted that the physical memory allocation always happens with case I or case II of FIG. 3. The use of case III requires a contiguous memory allocation of no less than 2 KB. Likewise, the use of case IV requires a contiguous memory allocation of at least 32 KB. This way, the channel allocation style can change with contiguous allocations.

Several further embodiments of the present invention will now be described, merely to illustrate how the invention may be implemented, and without limiting the scope or coverage of what is described elsewhere in this application.

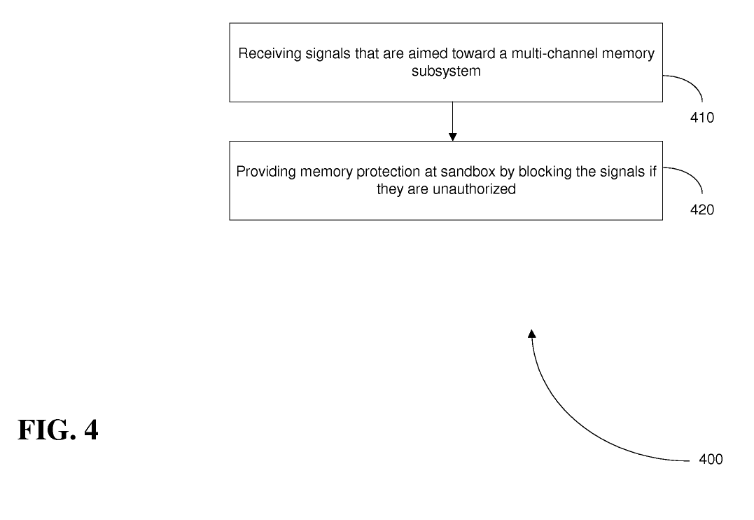

As shown in FIG. 4, the present invention includes a first aspect that is a method 400 comprising: receiving 410 signalling at a single sandbox, said signalling being aimed toward a multi-channel memory subsystem within an application processing architecture; and, providing 420 memory protection at said sandbox at least by controlling memory usage and blocking said signalling if said signalling is unauthorized, wherein said signalling via said single sandbox leads to a plurality of different memory locations if said signalling is authorized, said sandbox being an intermediary for substantially all execution memory accesses to said multi-channel memory subsystem.

The present invention also includes a second aspect which is the method of the first aspect, wherein said signaling is from at least one microprocessor core subsystem that is part of said architecture.

The present invention also includes a third aspect which is the method of the first aspect, wherein said signaling is from a video or graphics subsystem that is part of said architecture.

The present invention also includes a fourth aspect which is the method of the first aspect, wherein providing said memory protection includes determining which channel an address belongs to, and also determining what address bits to use for a respective channel.

The present invention also includes a fifth aspect which is the method of the first aspect, wherein said sandbox includes scatter-gather functionality.

The present invention also includes a sixth aspect which is the method of the first aspect, wherein said sandbox is accessed using a physical address, a process identification, and a read or write command, and wherein said sandbox reads a page table to determine if said signaling is unauthorized.

The present invention also includes a seventh aspect which is the method of the sixth aspect, wherein said providing the memory protection includes implementing an access request only if said process identification equals a table process identification for said physical address, and wherein said implementing the access request includes converting a physical address to a channel address.

The present invention also includes an eighth aspect which is the method of the first aspect, wherein said sandbox manages a page table, wherein said sandbox is accessed either with an allocation request, or a de-allocation request, or an access request.

The present invention also includes an ninth aspect which is the method of the eighth aspect wherein an access request is implemented if an access process identification equals a table process identification and a matching virtual address is mapped in said page table.

The present invention also includes a tenth aspect which is the method of the eighth aspect wherein said sandbox generates a process identification, wherein said page table tracks originators of memory allocations, and wherein an access request is implemented only if the process identification, and interconnection address, and a virtual address range match.

The present invention also includes an eleventh aspect which is the method of the sixth aspect, also comprising determining what address bits to use for a respective channel, and using at least one most significant bit of said physical address to distinguish between clusters within said multi-channel memory subsystem, wherein the method includes determining which cluster an address belongs to, wherein said method further comprises using at least one other bit to define said respective channel, and wherein a plurality of other bits are interpreted as said address bits.

The present invention further includes a twelfth aspect that is an apparatus 520 comprising: a first interface 540 configured to receive signals from a system interconnect 510, said signals being aimed toward a multi-channel memory subsystem 530 within an application processing architecture; an authorization determination component 570 configured to provide memory protection at least by controlling memory usage and blocking said signals if said signals are unauthorized; and, a second interface 560 configured to provide at least part of said signalling to a plurality of different memory locations if said signals are authorized, said apparatus being an intermediary for substantially all execution memory accesses to said multi-channel memory subsystem. This apparatus may be considered a sandbox, and the apparatus can be implemented by a combination of hardware and software, including by a processing unit and/or circuitry as understood by a person of ordinary skill in the art.

The present invention also includes a thirteenth aspect which is the apparatus of the twelfth aspect, wherein said signaling is from at least one microprocessor core subsystem that is part of said architecture.

The present invention also includes a fourteenth aspect which is the apparatus of the twelfth aspect, wherein said signaling is from a video or graphics subsystem that is part of said architecture.

The present invention also includes a fifteenth aspect which is the apparatus of the twelfth aspect, wherein said authorization determination component is further configured to determine which channel an address belongs to, and also what address bits to use for a respective channel.

The present invention also includes a sixteenth aspect which is the apparatus of the twelfth aspect, wherein said apparatus includes scatter-gather functionality.

The present invention also includes a seventeenth aspect which is the apparatus of the twelfth aspect, wherein said authorization determination component is further configured to read a page table, and wherein said apparatus is also configured to be accessed using a physical address, a process identification, and a read or write command.

The present invention also includes an eighteenth aspect which is the apparatus of the seventeenth aspect, further configured to provide said memory protection at least by implementing an access request only if said process identification equals a table process identification for said physical address, and wherein said implementation of the access request also includes converting a physical address to a channel address.

The present invention also includes a nineteenth aspect which is the apparatus of the twelfth aspect, wherein said apparatus is further configured to manage a page table, and wherein said apparatus is additionally configured to be accessed either with an allocation request, or a de-allocation request, or an access request.

The present invention also includes a twentieth aspect which is the apparatus of the nineteenth aspect configured such that said access request can be implemented if an access process identification equals a table process identification, and a matching virtual address is mapped in said page table.

The present invention also includes a twenty-first aspect which is the apparatus of the nineteenth aspect wherein said apparatus is further configured to generate a process identification, wherein said page table is configured to track originators of memory allocations, and wherein said apparatus is additionally configured to implement said access request only if the process identification, and interconnection address, and a virtual address range match.

The present invention also includes a twenty-second aspect which is the apparatus of the seventeenth aspect, wherein said apparatus is also configured to determine what address bits to use for a respective channel, and to use at least one most significant bit of said physical address to distinguish between clusters within said multi-channel memory subsystem, and also to determine which channel an address belongs to, and to use at least one other bit to define said respective channel, and furthermore wherein a plurality of other bits are interpreted as said address bits.

The present invention further includes a twenty-third aspect that is an apparatus comprising: means for receiving signals from a system interconnect, said signals being aimed toward a multi-channel memory subsystem within an application processing architecture; means for providing memory protection at least by controlling memory usage and blocking said signals if said signals are unauthorized; and means for providing at least part of said signalling to a plurality of different memory locations if said signals are authorized, said apparatus being an intermediary for substantially all execution memory accesses to said multi-channel memory subsystem.

The present invention also includes a twenty-fourth aspect which is the apparatus of the twenty-first aspect, wherein said signaling is from at least one microprocessor core subsystem that is part of said architecture.

The present invention also includes a twenty-fifth aspect which is the apparatus of the twenty-first aspect, wherein said signaling is from a video or graphics subsystem that is part of said architecture.

The present invention also includes a twenty-sixth aspect which is the apparatus of the twenty-first aspect, wherein said memory protection includes determining which channel an address belongs to, and also determining what address bits to use for a respective channel.

The present invention also includes a twenty-fifth aspect which is the apparatus of the twenty-first aspect, wherein said means for providing memory protection includes scatter-gather functionality.

The present invention also includes a twenty-seventh aspect which is the apparatus of the twenty-first aspect, wherein said means for providing memory protection is also for reading a page table, and wherein said means for providing memory protection is also accessible using a physical address, a process identification, and a read or write command.

The present invention also includes a twenty-eighth aspect which is the apparatus of the twenty-seventh aspect, wherein said apparatus is also for determining what address bits to use for a respective channel, and for using at least one most significant bit of said physical address to distinguish between clusters within said multi-channel memory subsystem, and for determining which cluster an address belongs to, and for using at least one other bit to define said respective channel, and wherein a plurality of other bits are interpreted as said address bits.

The present invention includes a twenty-ninth aspect that is a computer program product comprising a computer readable medium having executable code stored therein; the code, when executed being adapted for: receiving signalling at a single sandbox, said signalling being aimed toward a multi-channel memory subsystem within an application processing architecture; and, providing memory protection at said sandbox at least by controlling memory usage and blocking said signalling if said signalling is unauthorized, wherein said signalling via said single sandbox leads to a plurality of different memory locations if said signalling is authorized, said sandbox being an intermediary for substantially all execution memory accesses to said multi-channel memory subsystem.

The present invention also includes a thirtieth aspect which is the computer program product of the twenty-ninth aspect, wherein said signaling is from at least one microprocessor core subsystem that is part of said architecture.

The present invention also includes a thirty-first aspect which is the computer program product of the twenty-ninth aspect, wherein said signaling is from a video or graphics subsystem that is part of said architecture.

The present invention also includes a thirty-second aspect which is the computer program product of the twenty-ninth aspect, wherein providing said memory protection includes determining which channel an address belongs to, and also determining what address bits to use for a respective channel.

The present invention also includes a thirty-third aspect which is the computer program product of the twenty-ninth aspect, wherein said sandbox includes scatter-gather functionality.

The present invention also includes a thirty-fourth aspect which is the computer program product of the twenty-ninth aspect, wherein said sandbox reads a page table, and wherein said sandbox is accessed using a physical address, a process identification, and a read or write command.

The present invention also includes a thirty-fifth aspect which is the computer program product of the thirty-fourth aspect, wherein said code is also adapted for determining what address bits to use for a respective channel, and using at least one most significant bit of said physical address to distinguish between clusters within said multi-channel memory subsystem, wherein said code is also for determining which cluster an address belongs to and for using at least one other bit to define said respective channel, and wherein a plurality of other bits are interpreted as said address bits.

The embodiments described above can be implemented using a general purpose or specific-use computer system, with standard operating system software conforming to the method described herein. The software (SW) is designed to drive the operation of the particular hardware (HW) of the system, and will be compatible with other system components and I/O controllers. The computer system of this embodiment includes the central processing unit (CPU) processor shown, comprising a single processing unit, multiple processing units capable of parallel operation, or the CPU can be distributed across one or more processing units in one or more locations, e.g., on a client and server. Memory may comprise any known type of data storage and/or transmission media, including magnetic media, optical media, random access memory (RAM), read-only memory (ROM), a data cache, a data object, etc. Moreover, similar to CPU, memory may reside at a single physical location, comprising one or more types of data storage, or be distributed across a plurality of physical systems in various forms.

It is to be understood that the present figures, and the accompanying narrative discussions of best mode embodiments, do not purport to be completely rigorous treatments of the method, apparatus, and software product under consideration. A person skilled in the art will understand that the steps and signals of the present application represent general cause-and-effect relationships that do not exclude intermediate interactions of various types, and will further understand that the various steps and structures described in this application can be implemented by a variety of different sequences and configurations, using various different combinations of hardware and software which need not be further detailed herein.

What is claimed is:

1. A method comprising:
receiving signalling aimed toward a multi-channel memory subsystem within an application processing architecture; and,
providing memory protection at least by controlling memory usage and blocking said signalling if said signalling is unauthorized,
wherein said signalling leads to a plurality of different memory locations if said signalling is authorized at a single sandbox, said sandbox being an intermediary for substantially all execution memory accesses to said multi-channel memory subsystem.

2. The method of claim 1, wherein said signaling is from at least one microprocessor core subsystem that is part of said architecture.

3. The method of claim 1, wherein said signaling is from a video or graphics subsystem that is part of said architecture.

4. The method of claim 1, wherein providing said memory protection includes determining which channel an address belongs to, and also determining what address bits to use for a respective channel.

5. The method of claim 1, wherein said sandbox includes scatter-gather functionality.

6. The method of claim 1, wherein said sandbox is accessed using a physical address, a process identification, and a read or write command, and wherein said sandbox reads a page table to determine if said signaling is unauthorized.

7. The method of claim 6, wherein said providing the memory protection includes implementing an access request only if said process identification equals a table process identification for said physical address, and wherein said implementing the access request includes converting a physical address to a channel address.

8. The method of claim 1, wherein said sandbox manages a page table, wherein said sandbox is accessed either with an allocation request, or a de-allocation request, or an access request.

9. The method of claim 8 wherein an access request is implemented if an access process identification equals a table process identification and a matching virtual address is mapped in said page table.

10. The method of claim 8 wherein said sandbox generates a process identification, wherein said page table tracks originators of memory allocations, and wherein an access request is implemented only if the process identification, and interconnection address, and a virtual address range match.

11. The method of claim 6, also comprising determining what address bits to use for a respective channel, and using at least one most significant bit of said physical address to distinguish between clusters within said multi-channel memory subsystem, wherein the method includes determining which cluster an address belongs to, wherein said method further comprises using at least one other bit to define said respective channel, and wherein a plurality of other bits are interpreted as said address bits.

12. An apparatus comprising:
a first interface configured to receive signals from a system interconnect, said signals being aimed toward a multi-channel memory subsystem within an application processing architecture;
an authorization determination component configured to provide memory protection at least by controlling memory usage and blocking said signals if said signals are unauthorized; and,
a second interface configured to provide at least part of said signalling to a plurality of different memory locations if said signals are authorized, said apparatus being an intermediary for substantially all execution memory accesses to said multi-channel memory subsystem.

13. The apparatus of claim 12, wherein said signaling is from at least one microprocessor core subsystem that is part of said architecture.

14. The apparatus of claim 12, wherein said signaling is from a video or graphics subsystem that is part of said architecture.

15. The apparatus of claim 12, wherein said authorization determination component is further configured to determine which channel an address belongs to, and also what address bits to use for a respective channel.

16. The apparatus of claim 12, wherein said apparatus includes scatter-gather functionality.

17. The apparatus of claim 12, wherein said authorization determination component is further configured to read a page table, and wherein said apparatus is also configured to be accessed using a physical address, a process identification, and a read or write command.

18. The apparatus of claim 17, also configured to provide said memory protection at least by implementing an access request only if said process identification equals a table process identification for said physical address, and wherein said implementation of the access request also includes converting a physical address to a channel address.

19. The apparatus of claim 12, wherein said apparatus is also configured to manage a page table, and wherein said apparatus is additionally configured to be accessed either with an allocation request, or a de-allocation request, or an access request.

20. The apparatus of claim 19 configured such that said access request can be implemented if an access process identification equals a table process identification, and a matching virtual address is mapped in said page table.

21. The apparatus of claim 19 wherein said apparatus is also configured to generate a process identification,
wherein said page table is configured to track originators of memory allocations, and
wherein said apparatus is additionally configured to implement said access request only if the process identification, and interconnection address, and a virtual address range match.

22. The apparatus of claim 17, wherein said apparatus is also configured to determine what address bits to use for a respective channel, and to use at least one most significant bit of said physical address to distinguish between clusters within said multi-channel memory subsystem, and also to determine which channel an address belongs to, and to use at least one other bit to define said respective channel, and furthermore wherein a plurality of other bits are interpreted as said address bits.

23. An apparatus comprising:
means for receiving signals from a system interconnect, said signals being aimed toward a multi-channel memory subsystem within an application processing architecture;
means for providing memory protection at least by controlling memory usage and blocking said signals if said signals are unauthorized; and
means for providing at least part of said signalling to a plurality of different memory locations if said signals are authorized, said apparatus being an intermediary for substantially all execution memory accesses to said multi-channel memory subsystem.

24. A computer program product comprising a computer readable medium having executable code stored therein; the code, when executed being adapted for:
receiving signalling at a single sandbox, said signalling being aimed toward a multi-channel memory subsystem within an application processing architecture; and,
providing memory protection at said sandbox at least by controlling memory usage and blocking said signalling if said signalling is unauthorized,
wherein said signalling via said single sandbox leads to a plurality of different memory locations if said signalling is authorized, said sandbox being an intermediary for substantially all execution memory accesses to said multi-channel memory subsystem.

25. The computer program product of claim 24, wherein said signaling is from at least one microprocessor core subsystem that is part of said architecture.

26. The computer program product of claim 24, wherein said signaling is from a video or graphics subsystem that is part of said architecture.

27. The computer program product of claim 24, wherein providing said memory protection includes determining which channel an address belongs to, and also determining what address bits to use for a respective channel.

28. The computer program product of claim 24, wherein said sandbox includes scatter-gather functionality.

29. The computer program product of claim 24, wherein said sandbox reads a page table, and wherein said sandbox is accessed using a physical address, a process identification, and a read or write command.

30. The computer program product of claim 29, wherein said code is also adapted for determining what address bits to use for a respective channel, and using at least one most significant bit of said physical address to distinguish between clusters within said multi-channel memory subsystem, wherein said code is also for determining which cluster an address belongs to and for using at least one other bit to define said respective channel, and wherein a plurality of other bits are interpreted as said address bits.
